(19) United States
(12) Patent Application Publication
(10) Pub. No.: US 2011/0056957 A1
(43) Pub. Date: Mar. 10, 2011

(54) Combination Multiple Vessel Cookware

(75) Inventor: Stanley Kin Sui Cheng, Hillsborough, CA (US)

(73) Assignee: MEYER INTELLECTUAL PROPERTIES LTD., Kowloon (HK)

(21) Appl. No.: 12/873,487

(22) Filed: Sep. 1, 2010

Related U.S. Application Data
(60) Provisional application No. 61/239,858, filed on Sep. 4, 2009.

(51) Int. Cl. A47J 27/00

(52) U.S. Cl. 220/573.4

(57) ABSTRACT

A cookware set has an inner and outer vessel and a lid that sealingly covers the outer vessel. The inner vessel is shorter than the outer vessel and nests therein at the rim with a passage for steam generated by simmering water in the outer vessel. The steam enters the passage to cook, steam or warm food held in the inner vessel. The combination is particularly suitable for cooking rice.

### CROSS REFERENCE TO RELATED APPLICATIONS

The present application claims priority to and the benefit of the US Provisional Patent application of the same title, filed on 4 Sep. 2009, having application Ser. No. 61/239,858, which is incorporated herein by reference.

### BACKGROUND OF INVENTION

The present invention relates to a cookware article and in particular to combination cooking vessel for steaming food, and more particularly for cooking rice.

The cooking of rice in a pot directly exposed to an external heat source, such as a flame or electric heating element, can be problematic due to the difficulty of controlling the temperature throughout the cooking cycle.

It is easy for inexperienced cooks to either boil over the water, or burn the rice if the temperature is not carefully controlled or the pot not closely watched. Electric rice cookers have become popular for this reason.

However, for many consumers electric rice cookers consume too much counter space, or do not produce rice with the desired texture. Further, electric rice cookers have limited capacity to minimize cost.

It is therefore a general object of the present invention to provide an improved means for cooking rice consistently on a stove top, avoiding the foregoing deficiencies of the prior methods and equipment.

### SUMMARY OF INVENTION

In the present invention, the first object is achieved by providing a article of cookware comprising an outer fluid retaining vessel having a bottom and substantially upright surrounding walls terminating at a first rim and having an inner diameter, an inner vessel fluid retaining vessel having a bottom and substantially upright surrounding walls terminating at a second rim, wherein the inner fluid retaining vessel is shorter than the outer fluid retaining vessel, and the diameter of the inner rim is narrower than the inner diameter of the outer vessel, a lid that sealingly engages at least one of the inner and outer fluid retaining vessel at the rim thereof, wherein the inner fluid retaining vessel further comprises at least one of a laterally extending flange and a plurality of laterally outward extending supports members for coupling to the outer fluid retaining vessel for nested suspension substantially therein on a rim coupled portion thereof, wherein the gap between the inner rim and the outer rim is partially open such that steam generated in the outer fluid retaining vessel can circulate into the volume of the inner fluid retaining vessel via the gap.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a cross-sectional elevation of a first embodiment of the vessel combination.

FIG. 1B is a cross-sectional elevation of the portion of the vessel lid region of FIG. 1A in a larger view

FIG. 2 is a plan view of the vessel combination in FIGS. 1A and 1B with the lid removed.

FIG. 3A is a cross-sectional elevation of an alternative embodiment of the vessel combination.

FIG. 3B is a cross-sectional elevation of the portion of the vessel lid region of FIG. 3A in a larger view.

FIGS. 4A and 4B are cross-sectional elevations of another alternative embodiment of the vessel combination.

FIG. 5 is a cross-sectional elevation of another alternative embodiment of the vessel combination.

FIG. 6 is a plan view of the embodiment of the vessel combination shown in FIG. 5 with the lid removed.

FIG. 7 is a plan view of another alternative embodiment of the vessel combination with the lid removed.

FIG. 8 is a cross-sectional elevation of another alternative embodiment of the vessel combination.

FIG. 9 is a plan view of the vessel combination in FIG. 8 with the lid removed.

FIG. 10 is a cross-sectional elevation of another alternative embodiment of the vessel combination.

FIG. 11 is a plan view of the vessel combination in FIG. 10 with the lid removed.

FIG. 12 is a cross-sectional elevation of another alternative embodiment of the vessel combination.

### DETAILED DESCRIPTION

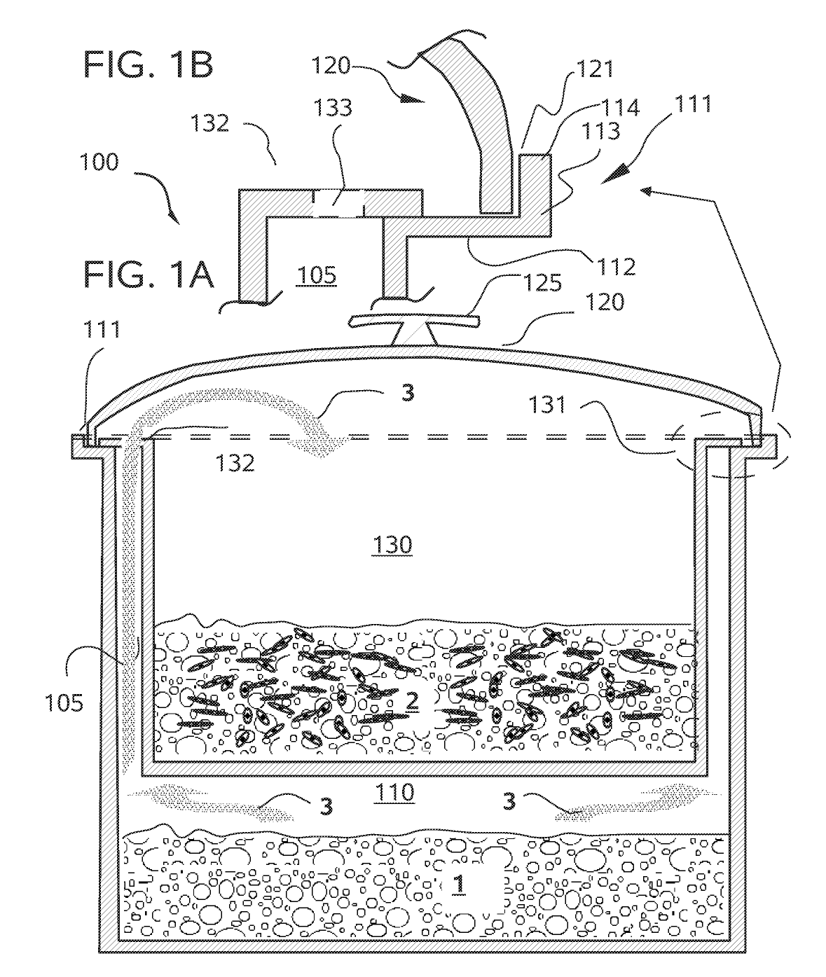

Referring to FIGS. 1 through 12, wherein like reference numerals refer to like components in the various views, there is illustrated therein a new and improved Combination Multiple Vessel Cookware, generally denominated 100 herein.

In accordance with the present invention, FIG. 1 illustrates an embodiment of the novel vessel combination 100, which includes an outer vessel 110, a lid 120 fitted to cover the outer vessel 110, and an inner vessel 130 that is shorter and has at least a lower fluid containing portion narrower than the upper vessel to nest therein with a gap 105 between their lateral walls. At least one of the inner and outer vessels having a means to support the bottom of the inner vessel upward above the bottom of the outer vessel. It is generally preferred that such a support means is integral with at least one of the inner and outer vessel. More preferably, the inner vessel 130 is suspended from the rim 111 of the outer vessel 110 to provide the gap 105 for steam or water vapors 3 generated by boiling water 1 in the lower portion of the outer vessel 110, that is below the inner vessel 130, so that these vapors diffuse to reach the contents of the inner vessel 130. Lid 120 has an upper handle 125 for removal from at least one of the inner and outer vessel, as is discussed further below.

One means of providing the gap 105 between the inner and outer vessel is for the inner fluid containing vessel 130 to have an outward extending flange 132 at the rim 131. The flange 132 is perforated with a plurality of holes 133 to allow steam 3 to enter the head space below the lid 120, and hence penetrate to the contents 2 of the inner vessel 130. In this embodiment, the flange 132 extends to a sufficient external diameter to rest on the rim 111 of the outer vessel 110. Thus, it should be appreciated that in this embodiment to retain steam 3, the lid 120 has a lower extending rim 121 dimensioned to sealingly engage the outer vessel 110 at a portion of the rim 111 to extend over and also cover the entire inner vessel 130, including the flange 132. More details of the engagement of the vessels and lid at their respective rims are shown in FIG. 1B. Rim 111 has an outer peripheral and laterally extending flange portion 112 followed by an upward wall 113 to fully seat the lower rim 121 of the lid 120.

Thus, water 1 boiled or simmering in the bottom of the outer vessel 110 produces steam 3 which can enter gap 105, and flowing through holes 133 in flange 132, can penetrate rice 2 or other foodstuff, such as other grains, vegetables, dumplings and the like in inner vessel 130.

For cooking rice, water and rice grains are placed in the inner vessel 130, with water placed in the outer vessel 110. As the inner vessel 130 is heated by the water boiling in the outer vessel, the water or contents of the inner vessel is never overheated to a rolling boiling and hence does not foam up and spill or leak at the converge of the rim 131 with the lid 120. Further, as the rice completes cooking it can never dry out and burn even when the water placed in the inner vessel 130 is totally absorbed by the rice, as it receives steam or water vapor generated in the lower vessel. Even in the case of the unlikely consumption of all the water in the outer vessel 110, the inner vessel 130 contents will not reach the temperature of the external heat source.

Further, the thermal mass of the water in the outer vessel 110 after cooking, as well as the abundant moisture surrounding the cooked rice in the inner vessel 130 will keep it both warm and moist for a long period of time. It is expected that other grains can be cooked in a similar manner with comparable benefits, as well as steaming food in the inner vessel 130 with adding water.

Hence, the vessel combination 100 is extremely versatile, being suitable for use as a rice cooker, steamer and double-boiler. It use provide cooks with a means to consistently cook rice to pleasing texture and flavor, avoiding over stickiness of the grains. Use of the vessel combination as described above also avoids foaming and over-boiling of water than can occur when cooking rice on a gas or electric range. The vessel combination can be readily scaled to large sizes for institution use, as in smaller size for home cooking Depending on the vessel capacity, it can be left on low heat or simmer for an hour or two without burning or over cooking

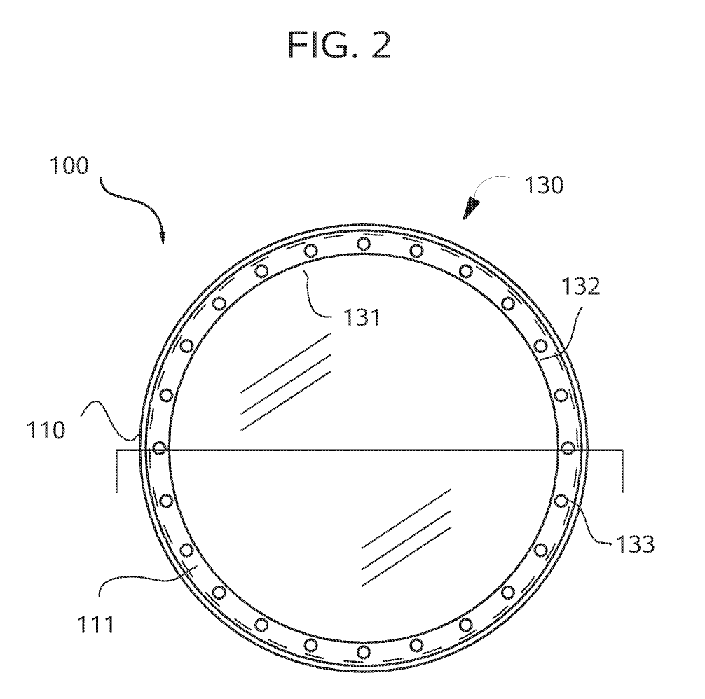

It is preferred that the perforation in the inner vessel flange 132 are a series of holes 133 equally spaced along the circumference thereof, as shown in the plan view of the vessel in FIGS. 1A and 1B in FIG. 2. Alternative means of providing vapor communication between the head space above the outer vessel 110 and the interior of the inner vessel 130 are illustrated in other figures for different embodiments, as described below, and may include differently shaped perforation.

In general, to support the inner vessel 130 inside the outer vessel 110, it is currently preferred that the rim of the outer fluid retaining vessel 110 comprises an outward extending portion 112 followed by an upward extending portion 113 that terminates at the rim's outer periphery 114.

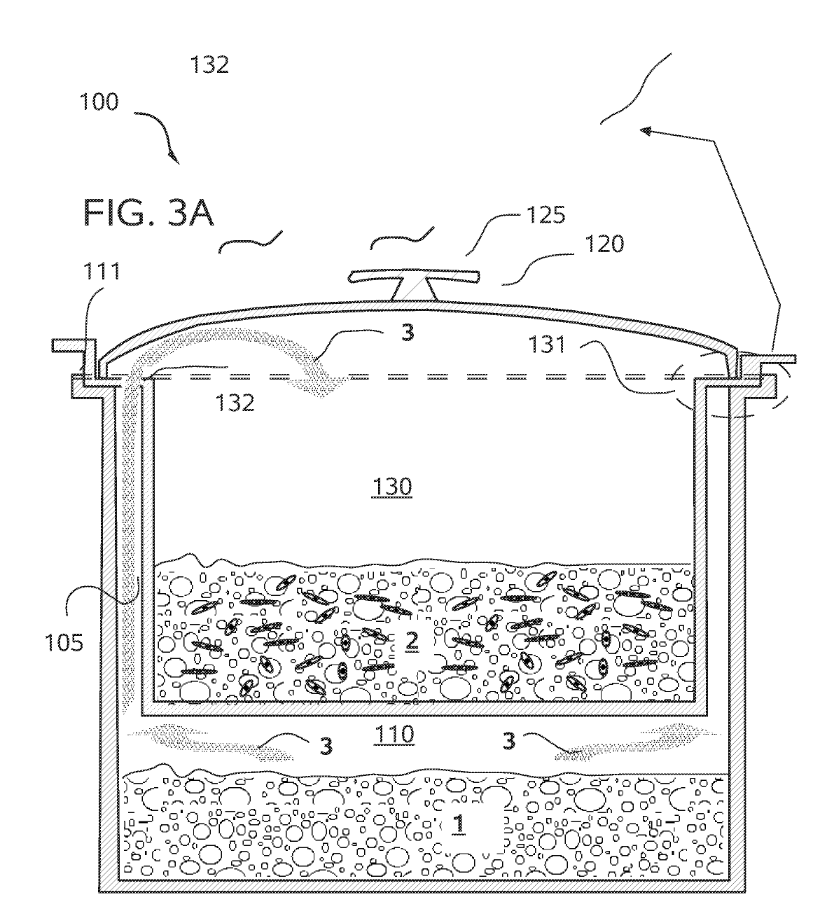

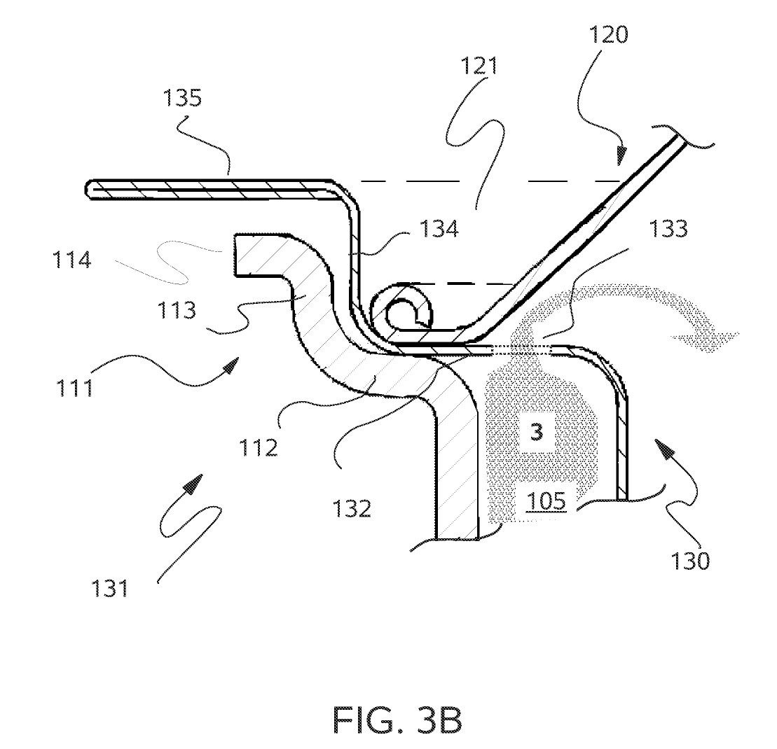

FIGS. 3A and 3B illustrate a more preferred embodiment where the inner vessel is easily removed after cooking is complete. As can be seen in FIG. 3B, the lower rim 121 of the lid 120 now engages the outward extending flange portion of the inner vessel 130.

The inner vessel 130, as shown in FIG. 3b, has two flanges like portions, the first 132 extending substantially laterally from the periphery of the vessel wall that defines an inner rim. The first or inner flange 132 rests on or otherwise engages the rim 111 of the exterior vessel 110. A second outer flange 135 is also extends away substantially laterally, but connected to the inner flange 132 by a vertical wall 134. Thus, this second flange 135 extends above and beyond the outer extremity 114 of rim 111 of the outer vessel 110. The lid 120 now has a lower rim 121 that fits on the flange 132 just inside of wall 134. It should now be appreciated that the portion of the flange 132 just outside of the holes 133 seals to the mating portion 122 of the rim of the outer vessel 110.

After cooking, lid 120 is removed by handle 125, then, if desired for serving or thereafter for cleaning, the inner vessel can be removed by grasping the outer flange 135.

Most preferably, as shown in FIG. 3B, the mating lid and rims of can have a slight concave profile at the lower surface to trap a thin film of condensed water. This thin film of water will then provides a vapor seal at low internal pressures, hence fully utilizing the steam 3 generated during cooking This cooperative contour of the lid with the rim of the inner and outer vessel is commonly known as a waterless seal because so little steam escapes from the vessel before the seal is formed that the nature water content of foodstuff is sufficient to avoid adding extra water to the food. However, in the preferred method of using the inventive cookware, this “waterless” seal generally avoids excessive evaporation during cooking

As the inner vessel 110 can have a thinner exterior wall that the exterior vessel 120, which is subjected directly to a heating source. Thus, the end of the wall is preferably folded over as shown in FIG. 3B, to form a thicker outer flange 135 that extends far enough away from the heat source and the outer vessel 110 to remain relatively cool. However, an external handle can also be attached to flange 135 to provide greater convenience, if it is desired to serve directly from the inner vessel 130.

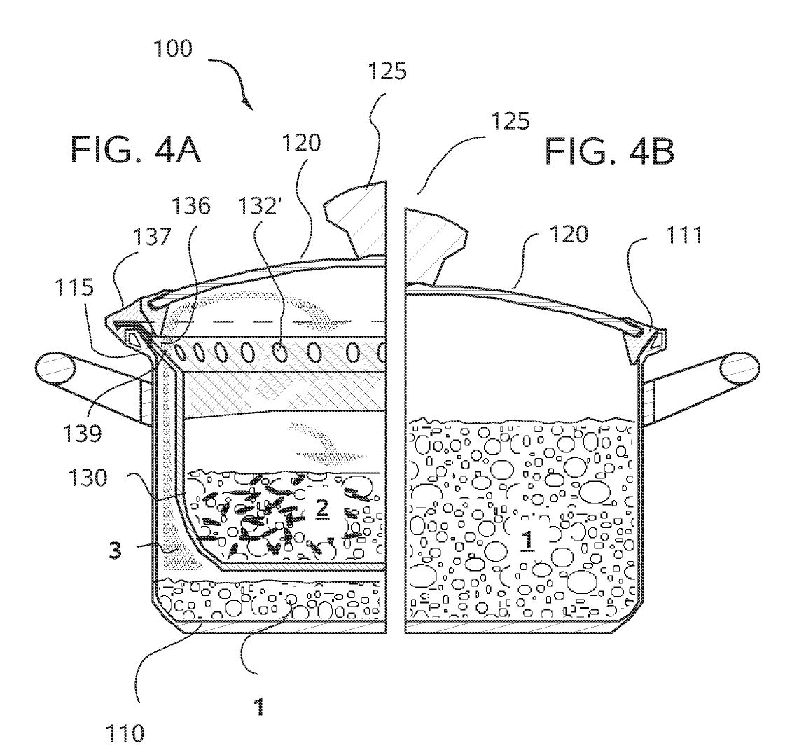

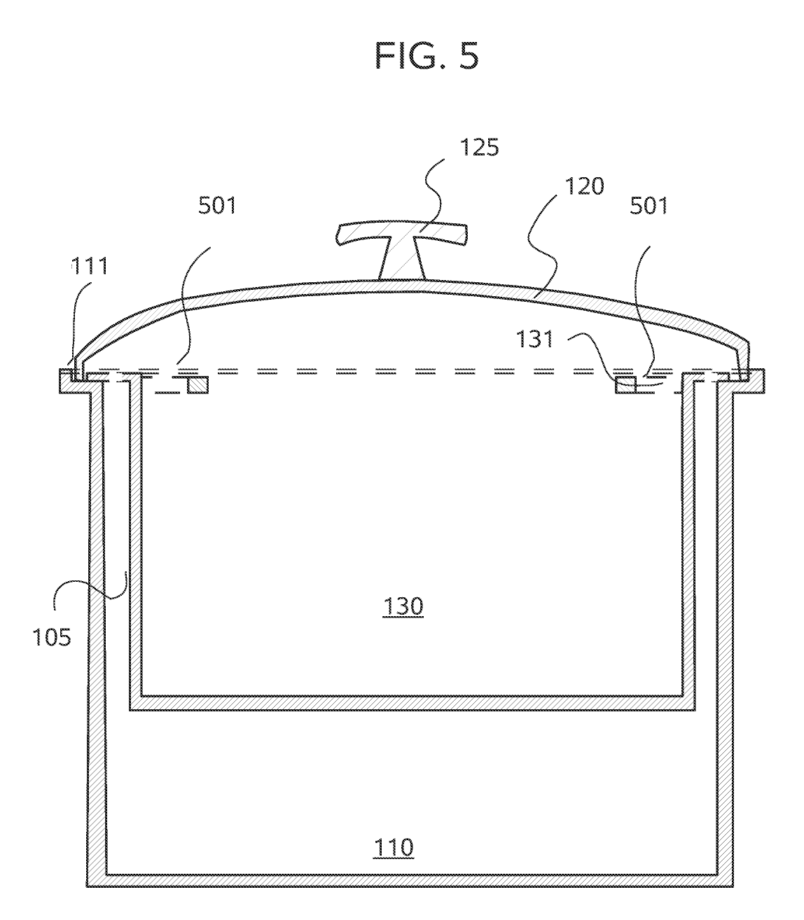

A similarly improved way of the removing the interior vessel 130 is provided by the embodiments shown in FIG. 4A, as well as FIGS. 5A and 5B. FIG. 4A shows an alternative combination vessel 100 as a partially cut-way cross section with the inner vessel 130 in place, and sealed by lid 120. FIG. 4B shows the other half of the outer vessel 110 with the inner vessel 130 removed, but also sealed by lid 120. In this embodiment the external portion 115 of the rim of the outer vessel 110 is tilted away from the vessel walls to conform generally to the complementary tilted profile of the outer vessel rim 111. The inner vessel 130 rather than having a substantially laterally extending flange 132, now has a complimentary tilted or conical flange 132′ (which a laterally outward extending component) with a plurality of spaced apart holes 133 in the lower portion. Above holes 133 the conical flange extends upward to an upper solid portion 136 that is preferably coated with silicone rubber 139 where it contacts the rim 111 of the outer vessel 110. This extreme external portion of tiled flange 132 has an external thermally insulating grip 137, such as a soft rubber but more preferably a silicone rubber grip along at least selected portion. Lid 120 is preferably transparent, more preferably also terminates at a rim 111 lined with a soft rubber or silicone rubber gasket. The external portion 115 of the rim of the outer vessel 110 and the inner and outer portion of the rim 136 of the inner vessel have the same shape or profile, in this instance conical, as the gasket at rim 111, so that when the inner vessel 130 is removed, as in FIG. 4B, the lid 120 sealingly engages the rim of the outer vessel 110.

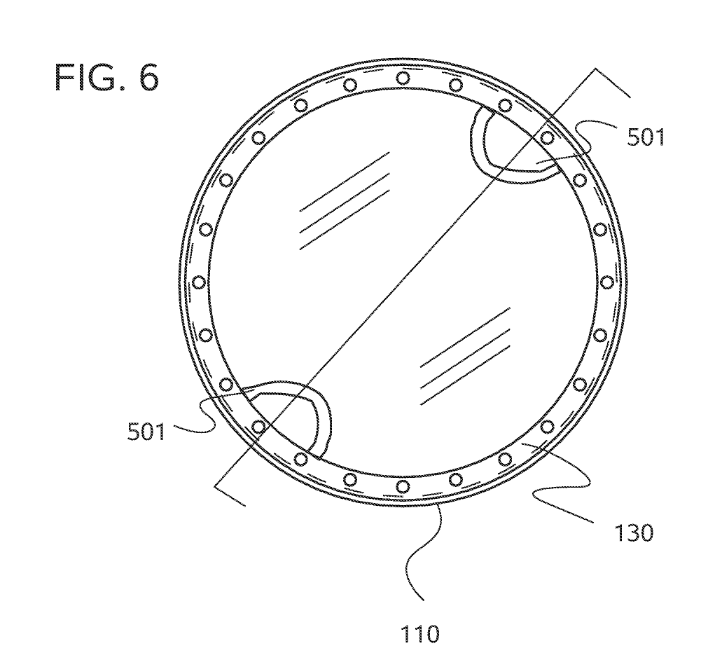

In the embodiment shown in FIGS. 5 and 6 the inner vessel 130 has handles 501 extend inward for gripping and removal, after lid 120 is removed.

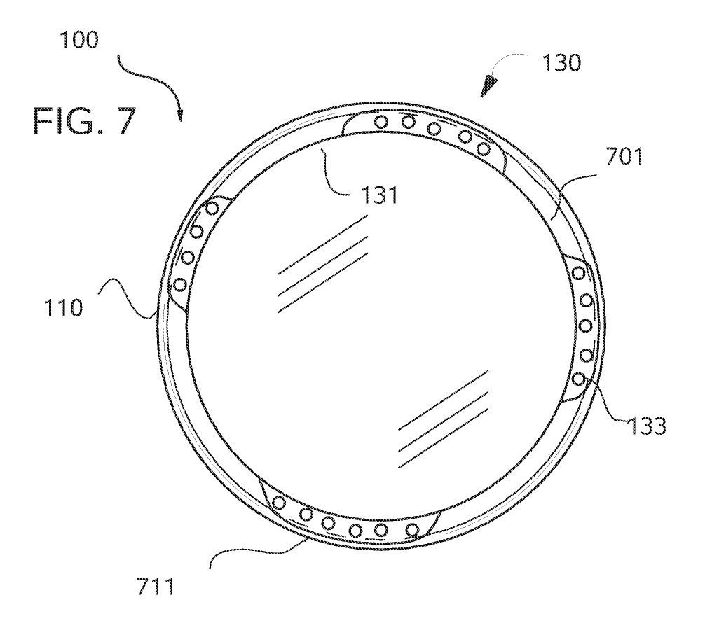

In the embodiment of FIG. 7, the flange 132 of the inner vessel 130 does not continue along the entire periphery, providing gaps 701 between portions of the flange 711 having a plurality of holes 133. Thus, depending on the size of these gaps, the need for holes may be eliminated. Further, improvements to this embodiment include providing any of the handle or gripping means for the inner vessel 130.

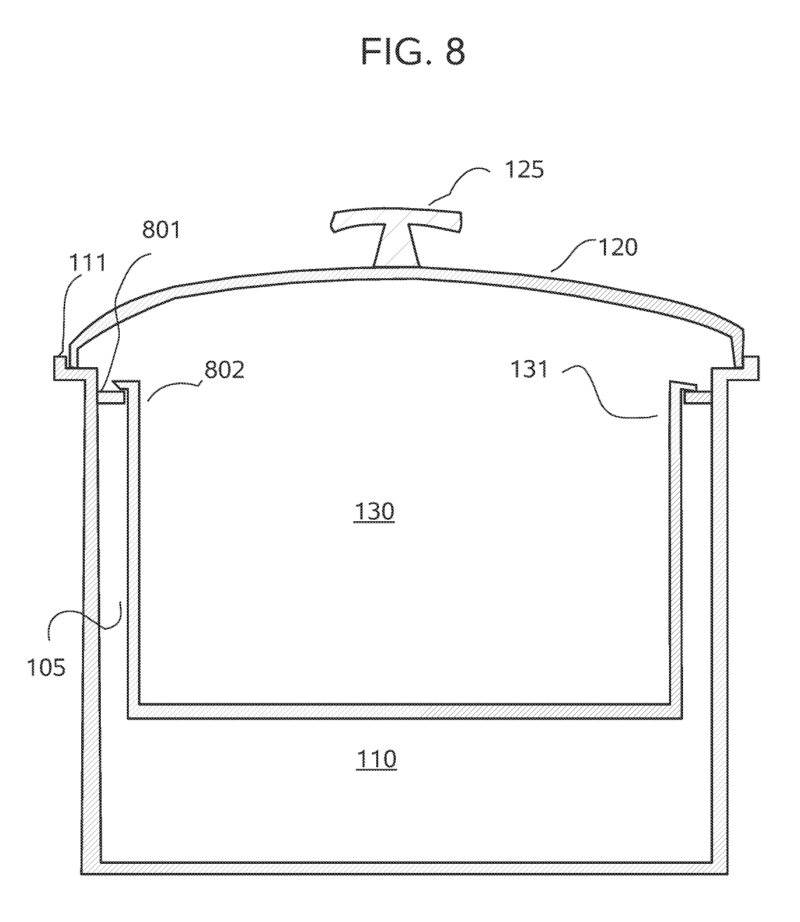

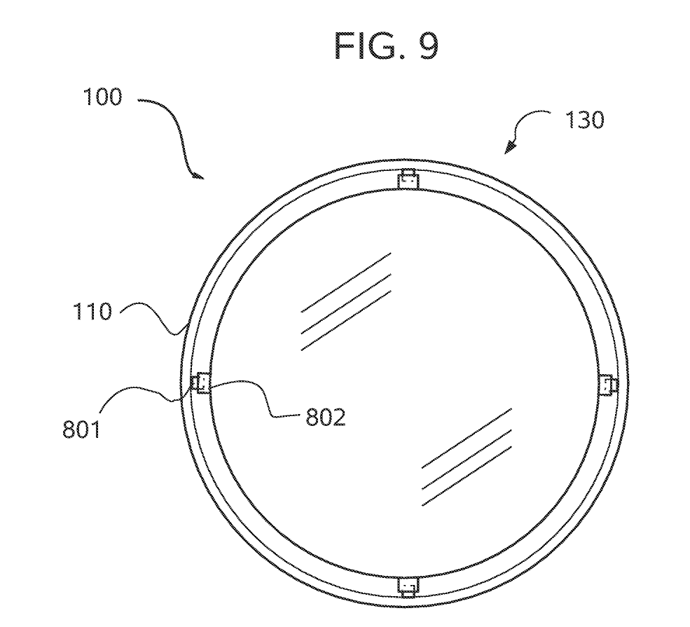

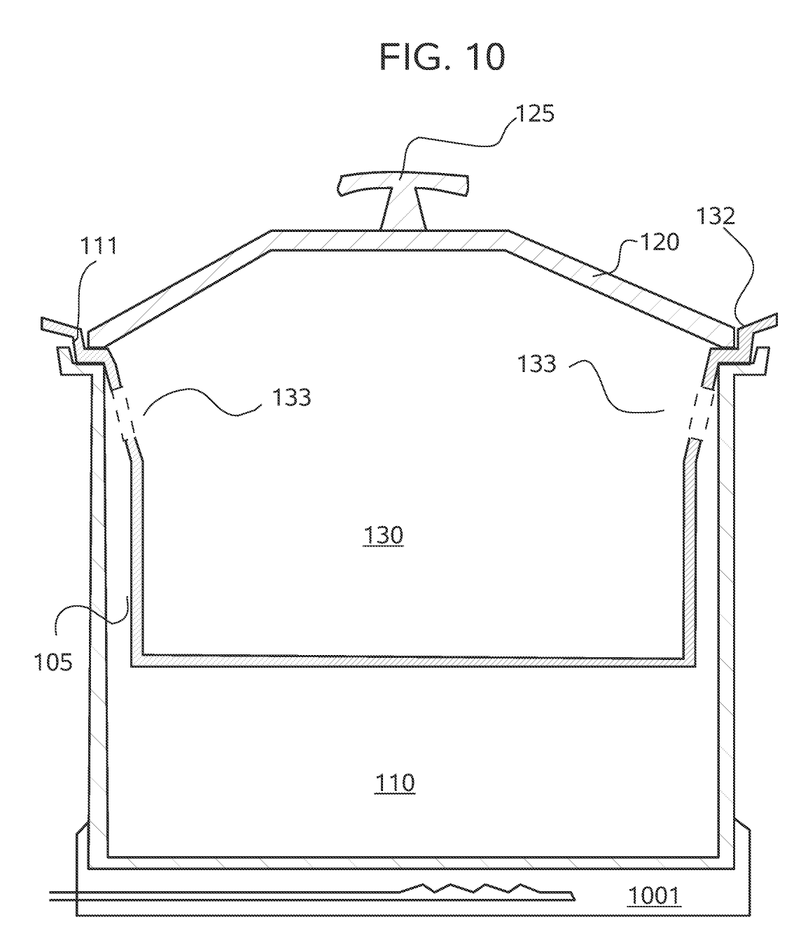

A shown in the embodiment of FIGS. 8 and 9, the outer fluid retaining vessel 110 can deploy an inward directing supporting means, such as an inner flange, shelf or posts 801 to support the inner fluid retaining vessel 130. The inner retaining vessel 130 can have a complete flange 132 as shown in FIG. 1-4, the partial flange portion 711 shown in FIG. 7, or mating supports 801 that rest on a plurality of posts or stubs 801 that internally extend from the upper wall portion of the outer vessel 110, and the like.

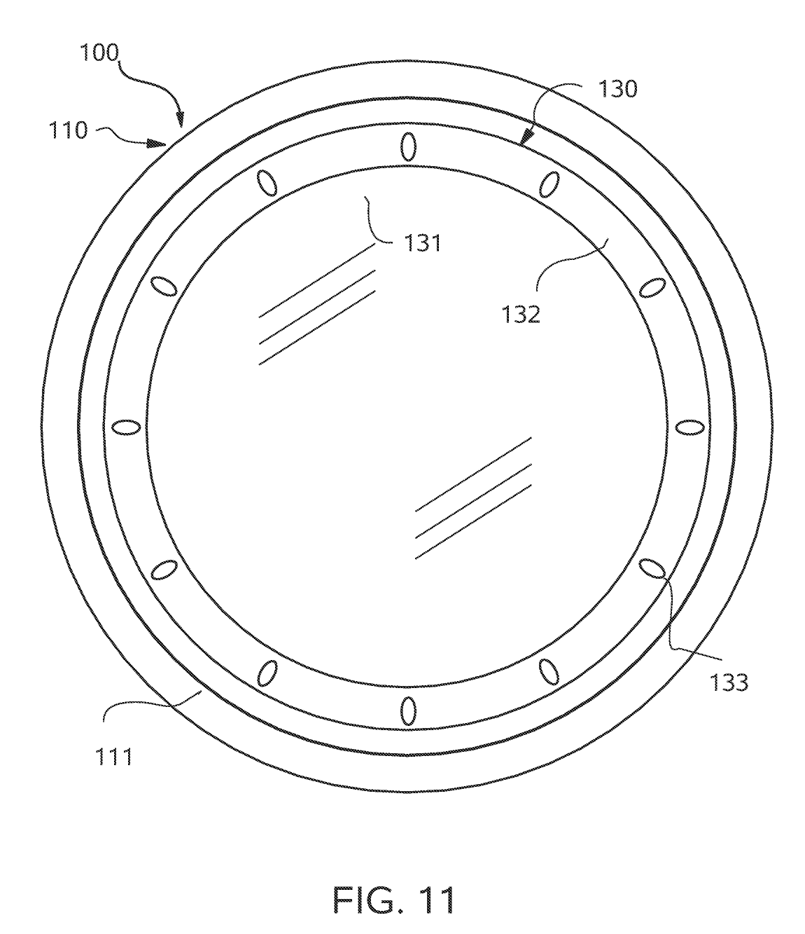

As also shown in the embodiment of FIGS. 10 and 11, the outer fluid retaining vessel 110 can have an integrated bottom heating element 1001, with appropriate control for temperature regulation, as well as external insulation.

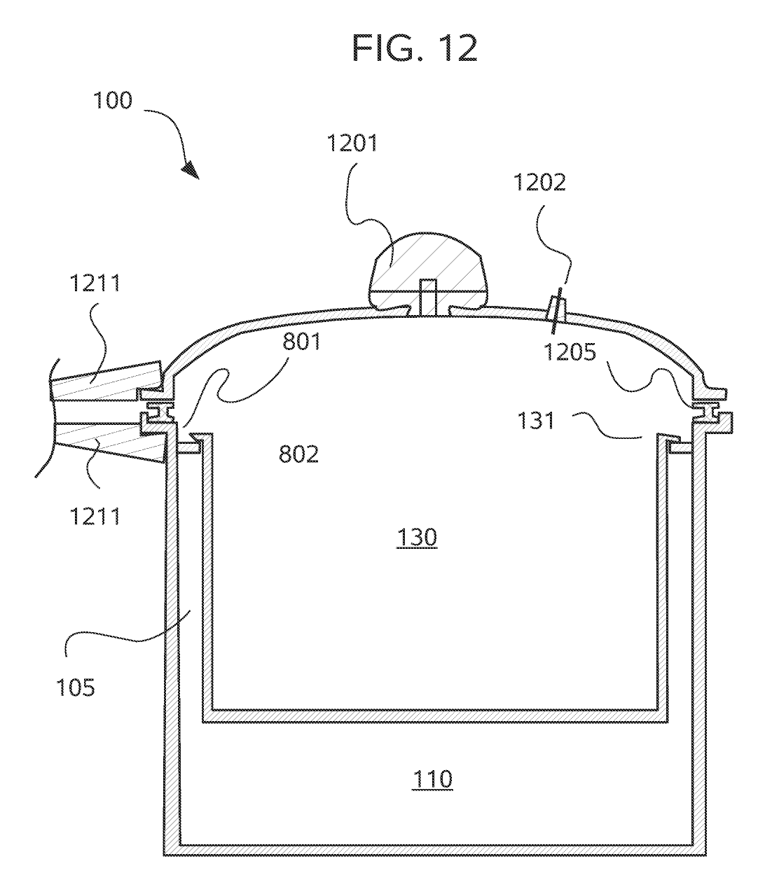

It should also be apparent that the lid 120 can have a pressure retaining engagement via an o-ring 1205 to the outer vessel 110 and a pressure release means, as shown in FIG. 12. In this embodiment, the outer vessel 110 and lid 120 are sealed by rotating the laterally extending handles pair 1210 and 1211 with respect to each other until they reach an engaged position that compresses the O-ring 1205. The inner vessel 130 remains entirely within the outer vessel 110 and thus avoids inference with the sealing mechanism. The lid has multiple pressure release valves 1201 and 1202.

In light of the teaching of the above specification, it should now be apparent to one of ordinary skill in the art that specific features of the various embodiments can be combined with or eliminated from certain embodiments to form a range of alternative devices that accomplish the same or comparable results. Thus, while the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. An article of cookware comprising:
a) an outer fluid retaining vessel having a bottom and substantially upright surrounding walls terminating at a first rim and having an inner diameter,
b) an inner fluid retaining vessel having a bottom and substantially upright surrounding walls terminating at a second rim, wherein the inner fluid retaining vessel is shorter than the outer fluid retaining vessel, and the diameter of the second rim is narrower than the inner diameter of the outer vessel,
c) a lid that sealingly engages at least one of the inner and outer fluid retaining vessel at the rim thereof,
d) wherein the inner fluid retaining vessel further comprises at least one of a flange having a laterally extending portion and a plurality of laterally outward extending supports members for coupling to the outer fluid retaining vessel for nested suspension substantially therein on a rim coupled portion thereof,
e) wherein the gap between the inner rim and the outer rim is partially open such that steam generated in the outer fluid retaining vessel can circulate into the volume of the inner fluid retaining vessel via the gap.

2. An article of cook\ware according to claim 1 in which the flange of the inner fluid retaining vessel is substantially laterally extending.

3. An article of cook\ware according to claim 1 in which the flange of the inner fluid retaining vessel is conical and extends upward as it extends outward laterally.

4. An article of cookware according to claim 1 wherein a plurality of equally spaced apart holes in the laterally extending flange provide the partial opening such that steam generated in the outer fluid retaining vessel can circulate into the volume of the inner fluid retaining vessel via the gap.

5. An article of cookware according to claim 1 wherein said lid has a lower extending rim dimensioned to sealingly engage the outer vessel at a portion of the rim to extend over and also cover the entire inner vessel including the flange having a laterally extending portion.

6. An article of cookware according to claim 4 wherein the inner vessel has two flange like portions extending laterally form the periphery of the vessel wall, in which the first portion rests on or otherwise engages the rim of said vessel 110 and a second portion is connected to the first portion by a substantially vertical wall so that the second portion extends above and beyond the outer perimeter of the rim of the outer vessel.

7. An article of cookware according to claim 6 wherein said lid has a lower rim that sealingly engages on the first portion of the flange of the inner vessel.

8. An article of cookware according to claim 1 wherein said lid sealingly engages at least one of the inner and outer fluid retaining vessels via a rubber gasket.

9. An article of cookware according to claim 8 wherein the lid has a rim that terminates in a rubber gasket and the inner vessel flange is covered by a rubber gasket on a lower face that engages the rim of the outer vessel rim and on a upper face that engages the rim of the of the lid, wherein said rubber gasket extends beyond the rim of the outer vessel to provide an insulated means to grip and remove the inner vessel form the outer vessel.

10. An article of cookware according to claim 1 wherein a portion of the flange on the inner vessel extends beyond the mutual connection with the lid and outer vessel to provide a gripping means to remove the inner vessel form the outer vessel.

11. An article of cookware according to claim 1 wherein the inner vessel has at least two inward extending handles that provide a gripping means to remove the inner vessel form the outer vessel.

12. An article of cookware according to claim 1 wherein said lid sealing engages a portion of the rim of the of at least one of the inner and outer fluid retaining vessel that has a concave profile to trap a thin film of condensed water which then provides a vapor seal at low internal pressures

13. An article of cookware according to claim 1 wherein said lid sealing engages a portion of the rim of the outer fluid retaining vessel via pressure sealable gasket and the inner vessel is supported entirely within the outer vessel.

14. An article of cookware according to claim 1 further comprising a heating element integrated in thermal communication with at least the bottom of the outer vessel.

15. An article of cookware comprising:
a) an outer fluid retaining vessel having a bottom and substantially upright surrounding walls terminating at a first rim and having an inner diameter,
b) an inner fluid retaining vessel having a bottom and substantially upright surrounding walls terminating at a second rim, wherein the inner fluid retaining vessel is shorter than the outer fluid retaining vessel, and has a smaller diameter than the outer fluid retaining vessel to provide a gap there between, wherein the second rim has;
i) an inner portion capable of engaging with a least one of the wall of the outer fluid retaining vessel and the first rim to support the inner fluid retaining vessel within the outer vessel, and sealingly engages the rim of the outer vessel, and
ii) an outer portion that extends beyond the first rim of the outer vessel to provide a means for gripping and removing the inner vessel from the outer vessel,
iii) a plurality of aperture disposed inward of the point of sealed engagement with the outer vessel, wherein the gap between the inner rim and the outer rim is partially open such that steam generated in the outer fluid retaining vessel can circulate into the volume of the inner fluid retaining vessel via the gap
c) a lid that sealingly engages the outer portion of the rim of the inner fluid retaining vessel beyond the plurality of aperture disposed inward of the point of sealed engagement with the outer vessel.

16. An article of cookware according to claim 15 wherein the rim of the inner vessel is covered with rubber.

17. An article of cookware according to claim 15 the rim of the inner vessel is shaped to provide a waterless sealed to both the lid and the outer vessel.

18. A method of cooking comprising the steps of:
a) providing the cooking vessel of claim 1,
b) placing an aqueous fluid in the outer vessel,
c) nesting the inner vessel in the outer vessel,
d) placing at least on of a grain, rice and beans in the inner vessel,
e) adding an aqueous fluid to the inner vessel,
f) closing the lid to seal the inner and outer vessel,
g) heating the outer vessel such the aqueous fluid in the inner vessel is directly heated to cook the at least one of a grain, rice and beans in the inner vessel, which is simultaneously exposed to steam generated in the outer vessel.

19. A method according to claim 15 further comprising the step of removing the inner vessel and serving food from the inner vessel.
